(19) United States
(12) Patent Application Publication
(10) Pub. No.: US 2013/0159202 A1
(43) Pub. Date: Jun. 20, 2013

(54) SYSTEMS & METHODS FOR AUTOMATED ASSESSMENT FOR REMEDIATION AND/OR REDEVELOPMENT OF BROWNFIELD REAL ESTATE

(71) Applicants: THOMAS FRANCIS DARDEN, II, Raleigh, NC (US); JAMES KEVIN SZYPERSKI, Atlanta, GA (US)

(72) Inventors: THOMAS FRANCIS DARDEN, II, Raleigh, NC (US); JAMES KEVIN SZYPERSKI, Atlanta, GA (US)

(21) Appl. No.: 13/325,732

(22) Filed: Dec. 14, 2011

(51) Int. Cl. G06Q 50/16; G06Q 10/00

(52) U.S. Cl. 705/306

(57) ABSTRACT

Systems and methods for distributed, automated management of brownfield real estate asset remediation and/or redevelopment.

### BACKGROUND OF THE INVENTION

1. Field of the Invention

The present invention relates to assessment for investing in the remediation and/or redevelopment of real estate, and more particularly, to automated optimization of assessing, remediating and redeveloping brownfield real estate.

2. Description of the Prior Art

Prior art provides for general methods for real estate development project management, including brownfield projects.

By way of example the following are relevant prior art documents relating to brownfield real estate development: U.S. Pat. No. 7,774,184 & US Pub. No. 20080091283 for Brownfield workflow and production forecast tool assigned on the face of the document to Schlumberger Technology Corp., describing a computer-based method for conducting a technical assessment phase of a brownfield assessment plan including the steps of determining an optimal set of engineering tasks to be performed in the technical assessment phase, the engineering tasks are based on at least well, operations, and facilities data; performing analysis of the well, operations and facilities data based on one or more of well information, historical well data, geological well data.

U.S. Pat. No. 7,031,838—System and method for cradle-to-grave solution for investigation and cleanup of hazardous waste impacted property and environmental media. Assignee: Integrated Environmental Services, Inc. Describes a system for environmental data management, comprising an application including: A mapping module that generates an interactive graphical mapping interface of the site, the interactive mapping interface including links to environmental data from a site and related documents; An analysis module that analyzes the environmental data, including contaminants of potential concern (COPC) data; A risk assessment module that assesses the human health risks caused by COPCs at the site; And a remediation module that screens remedial technology for cleaning up COPCs.

US Pub. No. 20080208637—Method and system for assessing environmental risk associated with parcel of real property. Assignee: American International Group, Inc. Describes a method of assessing the environmental risk associated with a property comprising: Determining the current use or uses of a property; Determining an intended use or uses of the property; Determining whether the property will be redeveloped, and if not to be redeveloped then further providing an automatic quote for environmental insurance; Determining whether underground storage tanks are present on the property, and if so, then site with tanks is excluded from the environmental insurance; Determining water distance to nearest surface water; Determining a residential distance to a nearest residential property; Determining an agricultural distance to a nearest agricultural property; Using the above steps to generate an environmental risk assessment report, wherein the report does not involve a physical inspection of the property.

US Pub. No. 20100088139—Project management system adapted for planning and managing projects. Assignee: Schlumberger Information Solutions. Describes a method for planning and managing project plans associated with one or more projects in a business, the method including generating one or more output displays adapted for planning and managing the project plans of the one or more projects in the business and providing a user with a view into the project plans.

Further describes input data that may include information such as human knowledge and experience data, encapsulated knowledge, project-specific constraints, finance data, health safety and environmental data, human resource data, and summary daily report data. Further provides as an example of a typical project dashboard, an illustration of a production project for brownfield rehabilitation (FIG. 30).

US Pub. No. 20100042420—Environmental resource management system and method. Assignee: Not Listed; Inventors: Douglas C. Hutchinson. Describes a method for managing resource usage in an area for members of the area, comprising: Determining the initial resource status of the area; Creating modification standards for the area which have environmentally beneficial attributes; Monitoring the execution of modifications to the area by members of the area for conformity to the modification standards; Managing performance of the modifications to sustain the environmental attributes of the modifications; Further describes that the step of determining the initial resource status comprises the assessment of air, soil, water, flora, and fauna of the area. Further describes that this method may be used to manage development impacts on resources from initial status (including brownfield sites) through project completion and ongoing use.

US Pub. No. 20050226688—Geomorphology environmental remediation process and systems. Assignee: Ann Arbor Technical Services & Earth Tech, Inc. Describes a method for investigating a site for possible selective removal of sediment containing a contaminant, comprising: Calculating an adjusted contaminant concentration for one or more sediment zones in a site containing a water course. Further describes designing and implementing a remediation plan based on the determination of which of the sediment zones are in need of remediation.

U.S. Pat. No. 6,253,191 & U.S. Pat. No. 7,346,572—Brownfields investing. Assignee: CLHSM, LLC. Describes a brownfield investment vehicle for investing in brownfields-related projects that supports all aspects of a brownfield remediation/development/redevelopment project while shielding investors from environmental liability.

'191 describes a method for investing in brownfields comprising: Establishing a brownfields fund, the brownfields fund providing investment capital on a non-recourse basis for brownfields projects and remaining passive with respect to the brownfields projects; Receiving investor capital from investors; Approving an entity for the investment capital on the non-recourse basis for a respective one of the brownfields projects according to a predetermined criteria, the entity having an ownership interest in a brownfield associated with one of the brownfields projects; And providing investment capital on the non-recourse basis to the approved entity using at least some of the investor capital from the investors.

'572 describes similar methods for investing in brownfields and managing brownfields funds.

### SUMMARY OF THE INVENTION

The present invention relates to predictive-modeling-based optimization of brownfield redevelopment, including assessment of a property for investment quality, for remediation and/or redevelopment of brownfield redevelopment.

It is an object of this invention to provide systems and methods for assessment for investment, remediation and/or redevelopment of brownfield real estate property.

Accordingly, one embodiment of this invention is directed to assessment for investment, remediation and/or redevelopment including a network-based computer system having interactive software via web-based user interface for automated process methodologies for the assessment phases, remediation phases, and/or redevelopment phases of brownfield real estate property, including required steps in each of the phases.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram illustrating one embodiment of the invention (basic cloud computing schematic).

FIG. 2 is a flow diagram illustrating one embodiment of the invention (entitled Development Process Flow).

FIG. 3 is a flow diagram illustrating steps in one embodiment of the invention.

FIG. 4 is a schematic diagram illustrating one embodiment of the invention.

FIG. 5 is another flow diagram illustrating steps in one embodiment of the invention.

FIG. 6 is another flow diagram illustrating steps in one embodiment of the invention and related hierarchy of stages of the present invention systems and methods.

FIG. 7 is a diagram stages in an embodiment of the invention.

FIG. 8 is another flow diagram illustrating steps in one embodiment of the invention.

FIG. 9 is a diagram illustrating process roles in one embodiment of the invention.

### DETAILED DESCRIPTION

Referring now to the drawings in general, the illustrations are for the purpose of describing a preferred embodiment of the invention and are not intended to limit the invention thereto.

The present invention provides systems and methods for automated methodologies and/or tools accessible via a network, such as the Internet, for assessment for quality of investment, remediation and/or redevelopment including a network-based computer system having interactive software via web-based user interface for automated process methodologies for the assessment phases, remediation phases, and/or redevelopment phases of brownfield real estate property, including required steps in each of the phases. During the assessment phase, a deal assessment or an investment assessment is analyzed based upon identification of a prospective deal, identification of a deal partner, salient facts represented in a memo, an investment memo, business planning, an acquisition go/no-go decision, and asset management tools following property acquisition.

A salient facts memo template preferably includes at least the following as illustrated in TABLE 1 (immediately below):

TABLE 1

| | |
|---|---|
| Salient Facts Template | |
| [Project Name—Location] | |
| [Date] | |
| Summary | Location: city and state and metropolitan statistical area |
| | Deal description: property size, development plan and exit |
| | strategy |
| | Market: current market value and historic peak to trough change |
| | in property value |
| | Financing: capital requirements, capital commitments and debt |
| | structure |
| | Environmental: any perceived or actual, current or historic |
| | impacts at the property |
| | Expected return on investment: internal rate of return and |
| | multiple |
| Property | Summary of property, including size, previous uses, ownership |
| | history, existing structures and infrastructure, and other features. |
| Location/Market | Summary of the property location and overview of local market |
| | conditions. |
| Project | Summary of the business strategy, including acquisition, remediation, |
| | development and exit. |
| Sellers/Deal Partner | Description of the property seller, deal partner, equity investors and |
| | other relevant parties. |
| Community/ Politics | Summary of the extent of support and/or opposition to the project. |
| Environmental | Summary of perceived or actual, current or historic environmental |
| | impacts and remediation requirements. |
| Entitlements | Provide summary of zoning, land use classification and other permits |
| | associated with property entitlements. |
| Financing/Financial | Summary of capital commitments, debt, and other financial |
| Incentives | obligations, as well as any financial incentives. |
| Development Plan | Summary of development plan with breakdown of property types and |
| | market rates for each property type. |
| Estimated Revenue/ | Summary of projected revenue and preliminary costs for |
| Project Costs | redevelopment based on the development plan. |
| Economics | Estimates of return on equity based on proforma or back-of-the- |
| | envelope estimates (internal rate of return and multiple). |

Thus, the salient facts memo includes factors such as property description essential for identification, environmental evaluation, etc. required for analyzing the investment, rather than the procedures for project management. Steps required for remediation phase that follow building the foundation, which includes communicating core values of the project approach, i.e., core environmental values, language for operating agreements, etc., and following property acquisition, include the environmental management process, building the team, assessing and understanding the environmental issues and aspects of the project, developing environmental strategy and obtaining environmental remediation insurance, implementing the plan including preparing the site for safety and emergency responses, monitoring the process, reviewing strategy and ensuring environmental compliance; measuring performance including financial and environmental performance, conducting independent audits, and review by top management; continuous improvement to correct, prevent, and/or improve any issue presented, setting environmental performance goals and improving environmental performance. These steps ensure complete and integrated address of the environmental issues consistent with regulatory requirements, etc.

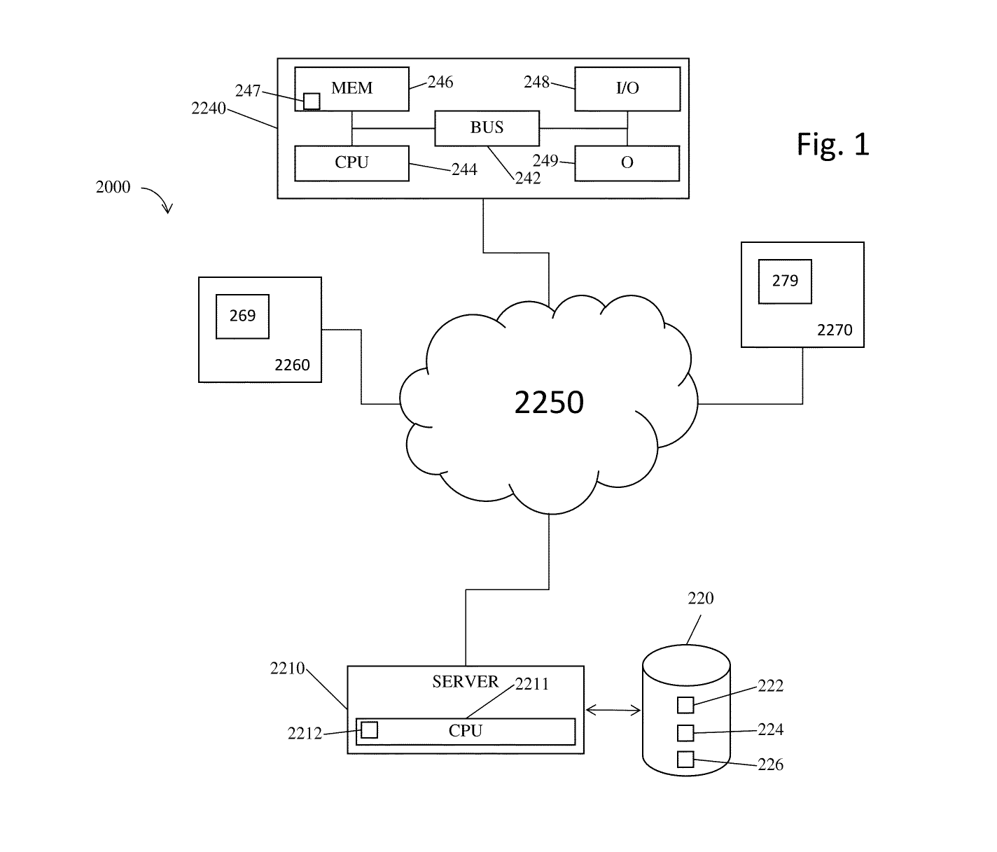

Preferably, a virtual network or cloud-based system is provided in support of a distributed network for interactive automated assessment of brownfield assets for considering investment, remediation and/or redevelopment, as illustrated in FIG. 1.

FIG. 1 is a schematic diagram of a networked system and remote server computer associated with the systems and methods of the present invention. As illustrated in FIG. 1, a basic schematic of some of the key components of the system including remote server computer and network access to the prediction market system, according to the present invention are shown. The system 2000 includes a server 2210 with a processing unit 2111. The server 2210 is constructed, configured and coupled to enable communication over a network 2250. The server provides for user interconnection with the server over the network using a personal computer (PC) 2240 positioned remotely from the server. Furthermore, the system is operable for a multiplicity of remote personal computers or terminals 2260, 2270. For example, in a client/server architecture, as shown. Alternatively, a user may interconnect through the network 2250 using a user device such as a personal digital assistant (PDA), mobile communication device, such as by way of example and not limitation, a mobile phone, a cell phone, smart phone, laptop computer, netbook, a terminal, or any other computing device suitable for network connection. Also, alternative architectures may be used instead of the client/server architecture. For example, a thin client system or other suitable architecture may be used. The network 2250 may be the Internet, an intranet, or any other network suitable for searching, obtaining, and/or using information and/or communications. The system of the present invention further includes an operating system 2212 installed and running on the server 2210, enabling server 2210 to communicate through network 2250 with the users thereof. The operating system may be any operating system known in the art that is suitable for network communication.

The present invention also provides systems and methods for optimized automated assessment, remediation and redevelopment of brownfield real estate property including the steps of: providing a server computer operable with software for storing and analyzing data associated with each of three phases of development, including an assessment phase, a remediation phase, and a redevelopment phase of brownfield real estate property assets; providing a database for storing data relating to prior developed brownfield assets compared to an evaluation date; assessment for remediation and/or redevelopment including a network-based computer system having interactive software via web-based user interface for automated process methodologies and/or tools and/or templates for the steps for reviewing brownfield real estate property redevelopment opportunities; providing at least one server computer, located centrally or distributed over a network and operable for remote interactive connection by at least one remote computer, at least one server computer in network communication with remote computer(s) for providing remote interactive user interface with the system and for receiving inputs from the remote server computer(s) regarding data from a first target brownfield asset, the server computer operable for generating instructions for review and management of any brownfield asset by way of automated comparison to similar prior developed brownfield assets represented by data in the database. A given user may have a multiplicity of brownfield asset targets being managed by the system under the present invention. Also, preferably the multiplicity of projects are automatically compared and contrasted with each other for a given user to systematically identify which properties are most closely following best practices, i.e., having most efficient and effective use of resources, success with remediation and redevelopment against goals, etc. By way of example and not limitation, criteria may be established based upon the specific user: a project manager will have different criteria that are project milestone-based, in contrast to an investor user who will be focused more on the economic criteria of a project, etc.

Advantageously, utilization of the systems and methods of the present invention provide for cost containment for the assessment, remediation and/or redevelopment of brownfield assets and increase confidence that the remediation process is structured, disciplined, and thorough. The method for optimized automated assessment and remediation of brownfield real estate property preferably includes the steps of: providing a server computer operable with software for storing and analyzing data associated with each of three phases of development, including an assessment phase, a remediation phase, and a redevelopment phase of brownfield real estate property assets; providing criteria for automatically determining if a project relating to a first target brownfield asset is conforming to standards for brownfield development; providing assessment for remediation and/or redevelopment including a network-based computer system having interactive software via web-based user interface for automated process methodologies and/or tools for the steps for reviewing brownfield real estate property redevelopment opportunities (or project); providing at least one server computer, located centrally or distributed over a network and operable for remote interactive connection by at least one remote computer, the at least one server computer in network communication with remote computer(s) for providing remote interactive user interface with the system and for receiving inputs from the remote server computer(s) regarding data from the first target brownfield asset, the server computer operable for generating instructions for review and management of the project for any brownfield asset. Also, preferably, the assessment phase includes an investment assessment to determine whether the project will provide at least a predetermined minimum return of capital plus profit on an investment of capital required to complete the project in a predetermined time.

The method further includes providing an environmental management system for automatically identifying errors, problems, and/or modification of process to address and/or prevent from occurring again; self-correcting process that is built into the EMS. Thus, the system and methods of the present invention provide automation based upon intellectual capital, including smart systems that provide automatic generation of steps based upon information from past projects, and preferably further including consideration of more recent or new errors and automatically creating a process to identify and prevent them in future projects with similar components or related facts, features, and/or characteristics.

The present invention provides an automated, integrated solution methodology and tools (MAP) that ensures systematic, high quality environmental results in a cost-efficient and effective manner by providing remote, interactive assessment and automated comparison to relevant, similar best practices and/or prior brownfield projects having data stored in the system database. The system and methods provide for tools, templates, and checklists and flow diagrams for automated project management with best practices that ensure time savings, cost savings, and consistent approaches for redeveloping unique brownfield real estate assets. Advantageously, the systems and methods of the present invention solve longstanding, unmet needs in this field, and are informed by processes based on years of experience, so that the multiple users (multi-users) of the system benefit from the experience themselves without having specific project and/or property data stored in MAP.

The Environmental Management System (EMS) that forms part of the present invention is ISO certified and requires continuous improvement and annual audits. This ISO certification is unique for a private equity real estate investment company. Because of the complexities of project management with brownfield remediation and/or redevelopment compared to greenfield real estate development, and environmental and regulatory issues, the present invention provides a streamlined, systematic, integrated and interactive website-based distributed network for multi-user access to project management of brownfield asset projects, including three major phases and the steps associated with each of them. The present invention methods and systems further include providing an environmental management system (EMS) for automatically identifying errors, problems, and/or modification of process to address and/or prevent from occurring again; self-correcting process that is built into the EMS. Thus, the system and methods of the present invention provide automation based upon intellectual capital, including smart systems that provide automatic generation of steps based upon information from past projects, and preferably further including consideration of more recent or new errors and automatically creating a process to identify and prevent them in future projects with similar components or related facts, features, and/or characteristics.

Notably, the multi-user access to project management under the present invention provides for multi-user on one project and/or multi-user on multiple projects. The multiplicity of MAP system distributed users are selected from the group consisting of Municipal officials (planning, housing, economic development, or parks and recreation department); State government; Policy specialists; Regulators; Developers; Facilitators or mediators; Engineers and scientists; Architects; Risk assessors/Fate and Transport of contamination experts; Environmental consultants; business leaders; Public sector financial representatives; Community leaders representatives/community members; Private funding source representatives; insurance representatives; private lenders; property owners; municipal public relations experts; Environmental protection agencies; Professionals making living providing services around brownfield redevelopment; and combinations thereof.

Another key feature and functionality of the systems and methods of the present invention is that EMS is a disciplined, structured and systematic methodology with automation and visualization tools that reduces changes of remediation short-cuts that could lead to problems in the future, including but not limited to health or environmental problems and combinations thereof.

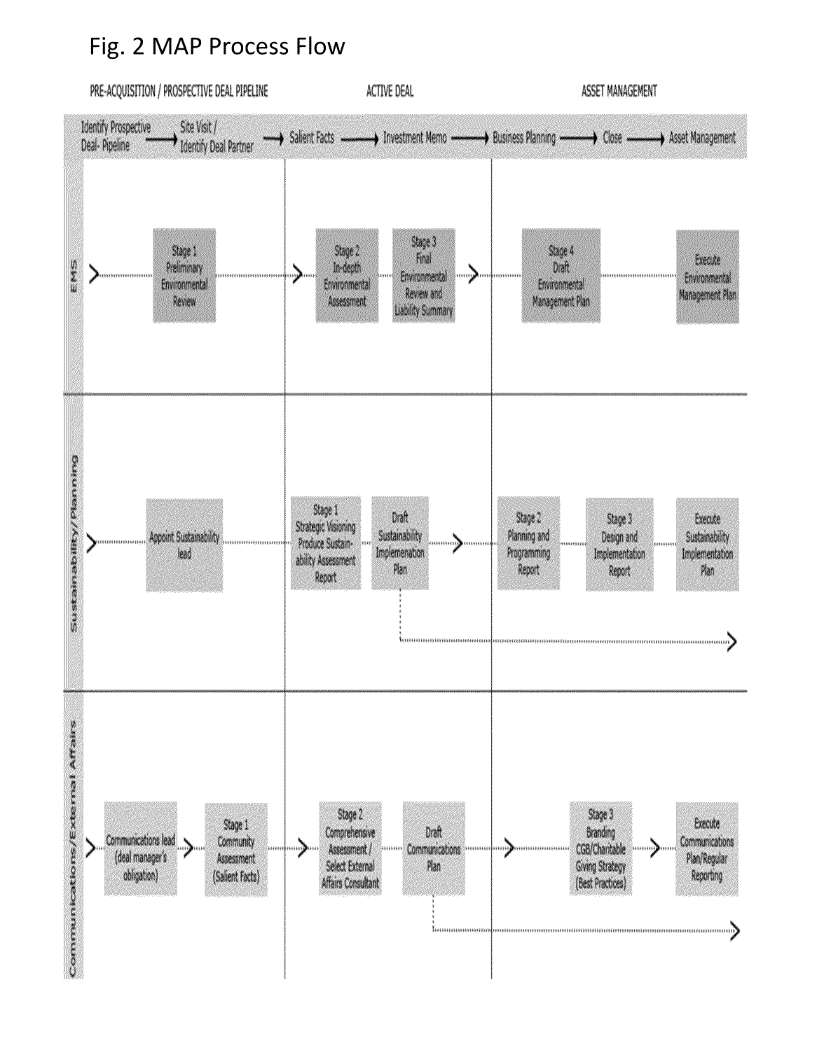

FIG. 2 is a flow diagram illustrating the MAP Process Flow according to the present invention.

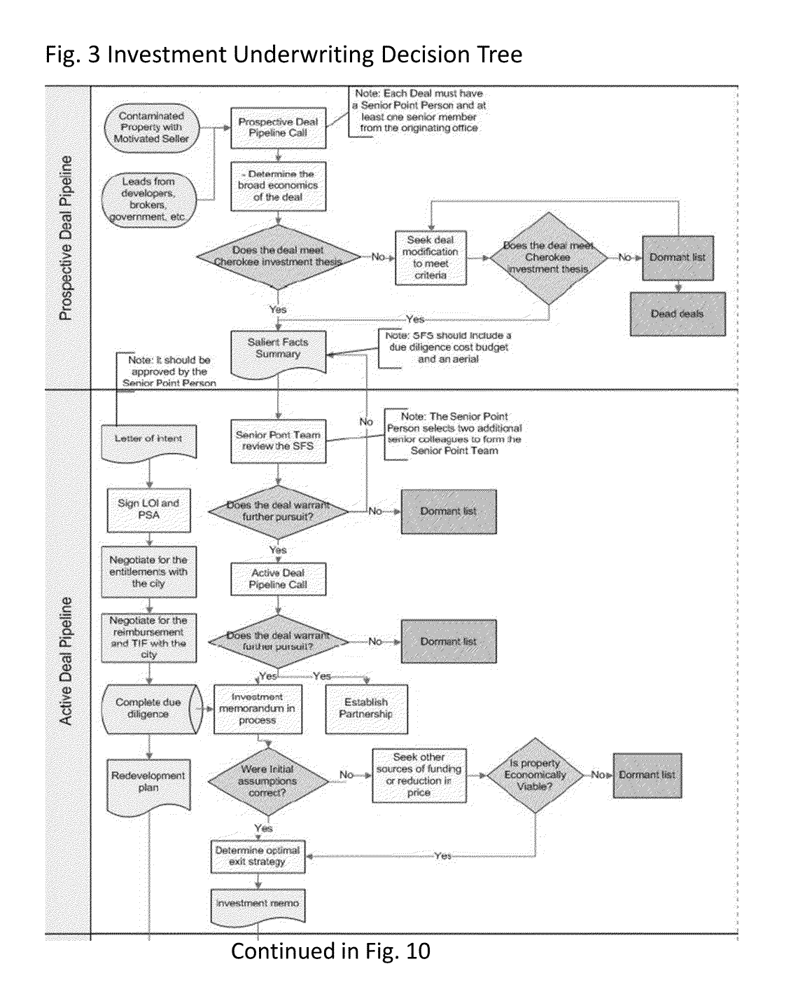

FIG. 3 is a flow diagram illustrating steps in the Investment Underwriting Decision Tree.

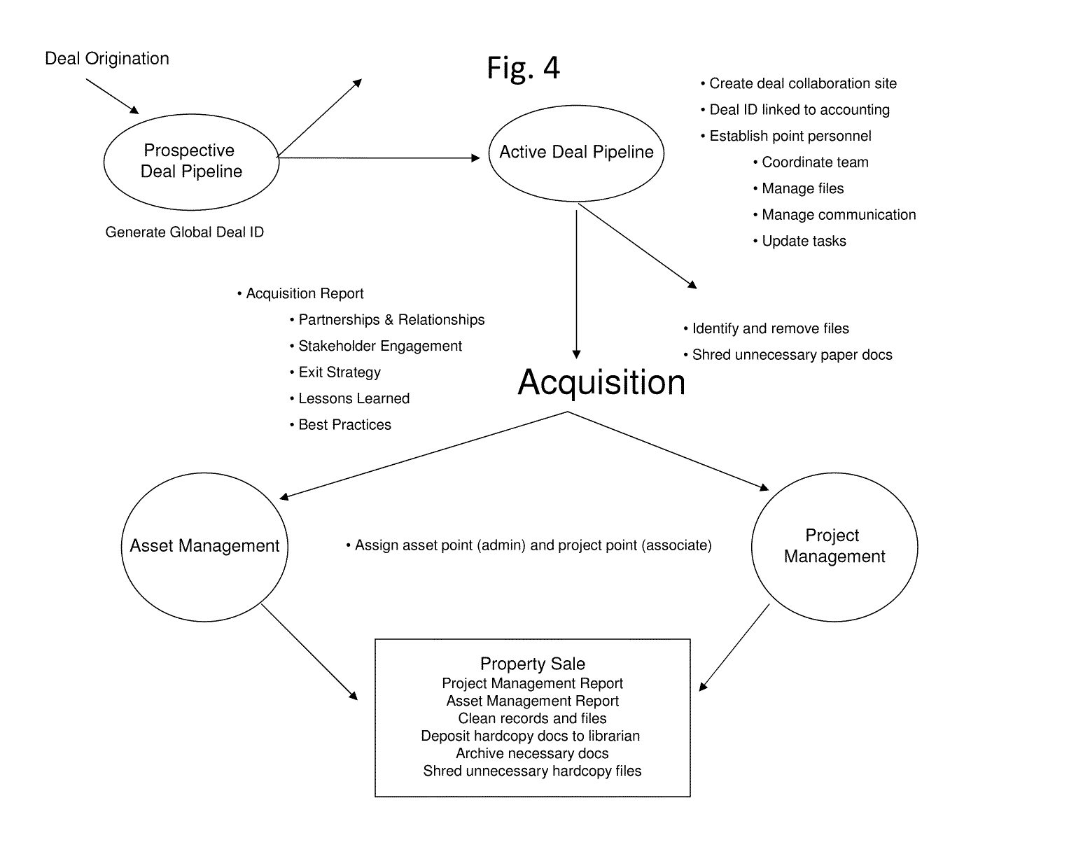

FIG. 4 is a schematic diagram illustrating steps in the Acquisition process.

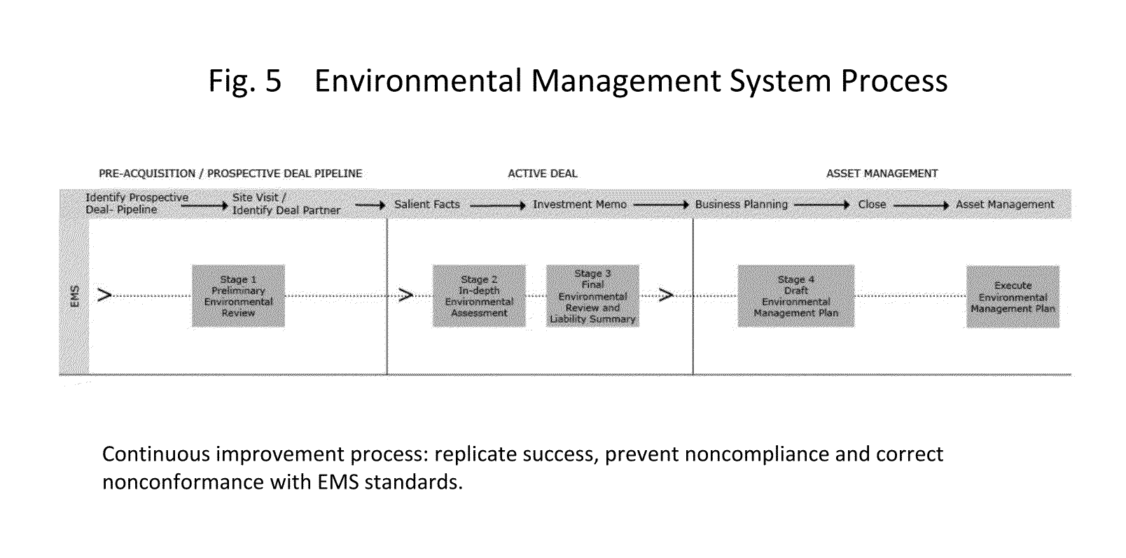

FIG. 5 is another flow diagram illustrating steps in the Environmental Management System process.

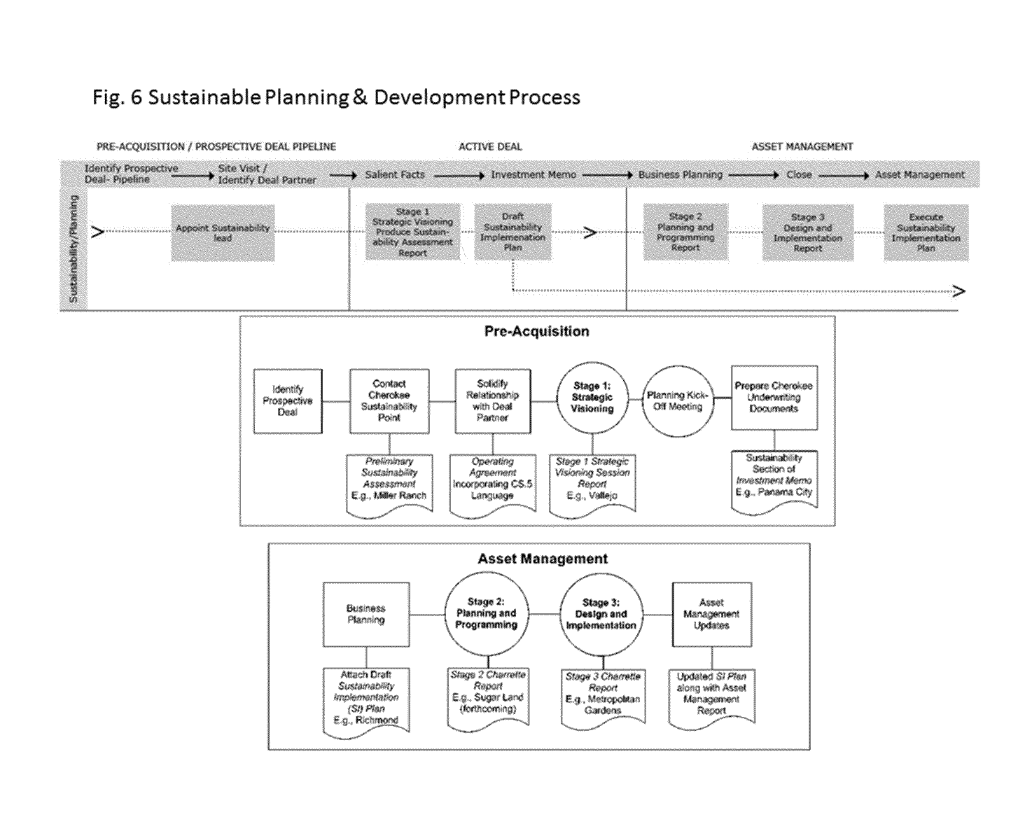

FIG. 6 is another flow diagram illustrating steps in one embodiment of the invention and related hierarchy of stages of the Sustainable Planning & Development process.

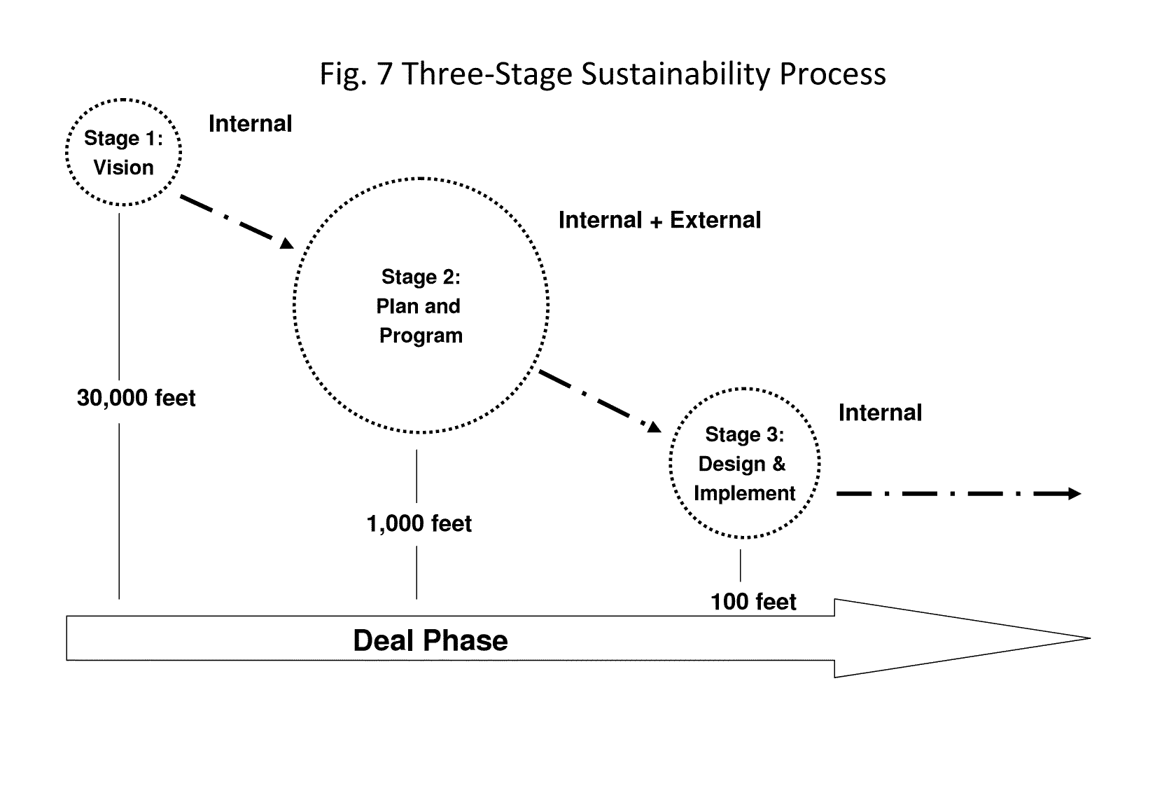

FIG. 7 is a diagram stages in the Three-Stage Sustainability Process.

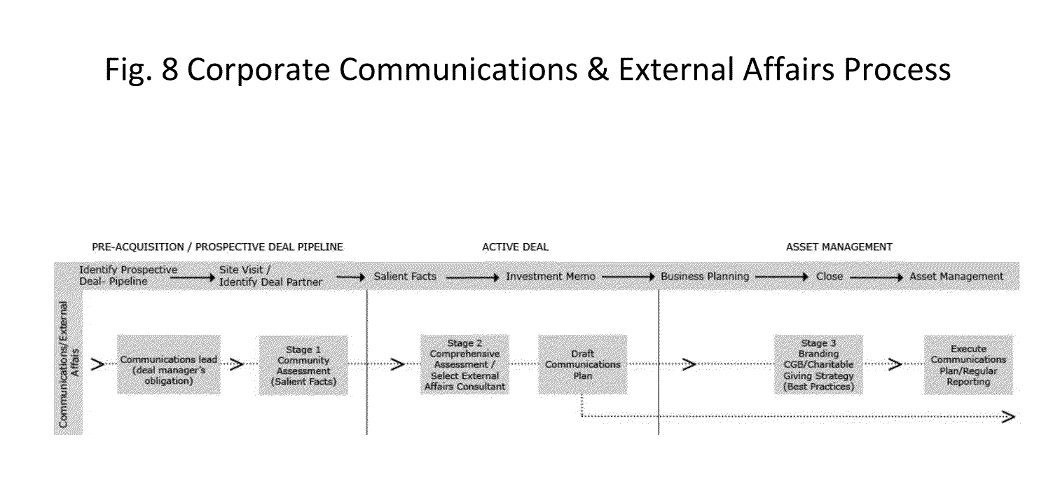

FIG. 8 is another flow diagram illustrating steps in the Corporate Communications & External Affairs process).

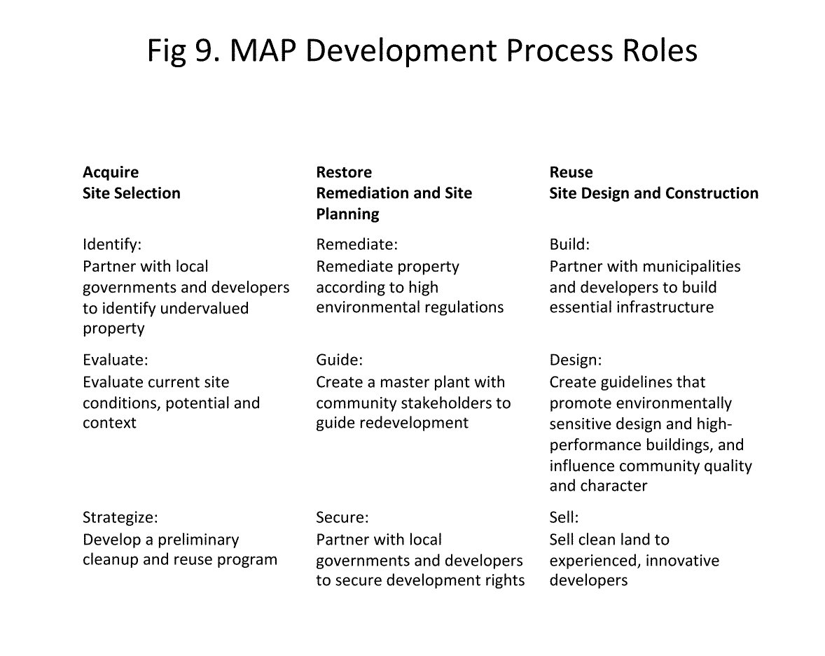

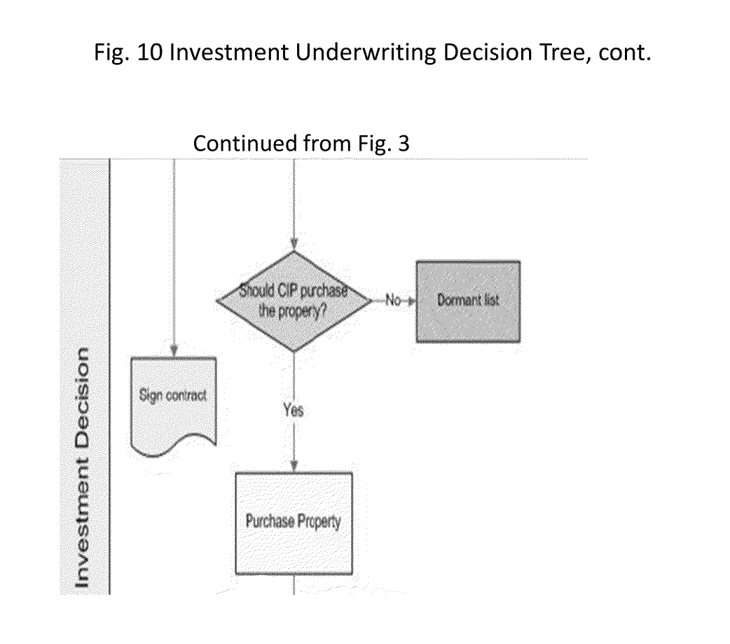

FIG. 9 is a diagram illustrating process steps in the MAP Development Process.

Features and benefits of the present invention include but are not limited to the following:

Inspires and motivates stakeholders by providing specific project case studies in a ‘before and after’ format to illustrate a brownfield redevelopment project's potential impact to convert an eyesore into an asset. Project benefits are economic, environmental and/or societal.

Modeling scenarios for returns on public/private investment to support Tax Increment Financing (TIF) or ROI for public investment.

Saving time and money while ensuring a complete consideration of pertinent issues by providing a structured and disciplined approach to measuring deals against a set of criteria.

Modeling a well-considered deal for third parties to emulate, which increase the likelihood that deal is funded, as well as the likelihood of the success of the project or deal.

Saving time and money by modeling a thorough set of pre-development plans that also serves as an excellent marketing piece for a project.

Reducing the risk of project failure because of project manager or any individual's errors, omissions, and/or failure to include all factors in planning a project.

Educating the distributed multiplicity of users on key issues and effective use of time and money in planning and executing a brownfield redevelopment project.

Saving significant time over planning a complex project without any “road map” or guidelines that are relevant specifically to brownfield projects, including automated comparisons to prior brownfield developments.

Saving time and encouraging high quality outcome by providing templates for decision-making documents, e.g., by way of example and not limitation, Salient facts, Investment memos and Asset management updates.

Saving time and encourages high quality outcome by providing spreadsheets that are automatically developed to support financial analysis and project management for brownfield asset management for a given project, wherein the remote multiplicity of users interactively input specific project numbers wherein the automated system and methods then generate thorough and sophisticated reports specific for tracking brownfield asset project management.

Sample deal documents that illustrate what products of various components should look like. Insurance documents educate users on the best strategies to manage and mitigate project risk and the specific financial instruments they may use to do so.

Providing automated deal analysis for users with “lessons learned” from prior projects that are directly relevant to the case in point and that help project leaders avoid mistakes, by providing customized comparables or case studies and workflow process diagrams and development checklists to ensure successful development outcomes.

Furthermore, providing an international standards organization-based automated system and methods for brownfield development includes the following features and benefits, by way of example and not limitation: Providing a structured, disciplined, cost efficient approach to managing the environmental portion of a redevelopment project. System establishes and articulates strong environmental principles and provides standard operating guidelines for execution.

EMS guides project managers in a 5 step-by-step process, a significant benefit in the complicated world of brownfield redevelopments where many struggle for direction. Standard Operating Guidelines direct user in the most efficient use of time and money while concurrently prescribing a high degree of environmental stewardship.

The present invention systems and methods successfully address the longstanding unmet need in the industry for providing automated, networked, and real-time access to templates and tools developed and refined over 20 years project experience with case studies, including EMS documents that are ready-to-use templates for saving time, helping to avoid mistakes by individuals, reducing expenses and/or risk, and improving safety.

The systems and methods of the present invention also enhance a user's credibility in brownfield development. By following the EMS, project leaders are making a statement to stakeholders that they are committed to quality and their commitment should translate into a systematically, proven process-based project methodology, including winning confidence of lenders, regulators, insurers, and others gain confidence that project management is thorough, disciplined and cost effective, and remotely viewable and monitorable by those entities, with secure and transparent access provided by the system user for a given project.

Also, a database of properties is provided for remote access by users, in particular for corporations owning a multiplicity of properties under development. This is particularly advantageous because brownfield development and regulations differ greatly by geographic location. Such a remote database provides for the remote users to search and research and compare projects according to a variety of factors, including but not limited to: a database of properties searchable and sortable by the following factors, and combinations thereof:

Location/geographical area

type pollutant/contamination

water, air,

chemical

active/inactive facility

size

value (estimated as is, clean, cost to clean)

short term v. long term asset

urban/rural

Status, e.g., No Further Action (NFA) letter in hand.

Phase 1 complete, etc.

In preferred embodiments of the present invention, different MAP skins or GUI formats are provided for different stakeholders to allow the system to customize MAP for different users and/or audiences to highlight most useful content for them. Also, a percent complete indicator is advantageously provided to automatically gauge or monitor progress and prompt users to take next steps.

Optionally an EPA grant point calculator and guide for grant applications is provided with the present invention; it is helpful to highlight progress and to encourage high quality, particularly on target applications, including the following factors: qualitative based on key words, and quantitative based on number of fields complete. A brownfield program application for online participation with a project is provided, including an example for new users to make the application or project account creation more efficient.

Visualization tools are helpful for soliciting community input and for demonstrating progress, either with actual photos and/or illustrations, as the project proceeds through various stages. These tools preferably provide for automatic updating at predetermined stages on a project management timetable. Alternatively, manual uploading of photographic images will trigger a corresponding automated updating of visual representations of the project that are available only to authorized project members, to the predetermined guest users, to the general public, and combinations thereof.

Preferably, in one embodiment of the present invention, an on-line version of visual representations of a project, including both images and text identifying the project phase is provided via an interactive website and graphic user interface (GUI). Where authorized, the system is adapted to allow at least one project manager to upload images and descriptions of their respective project sites to make their project image-based information available to third parties, including but not limited to universities and other creative, inexpensive design teams. Optionally, the project manager selectively authorizes multiple users from the general public to submit photographic images of the site(s) in their communities, thereby providing public exchange and input in tracking progress, and encouraging support locally for the project.

Other visualization tools include transformation slides showing illustrations of the property “as is” prior to project commencement and what it can look like in the future at predetermined stages of the project, including project completion; status reporting automatically triggered by updating images of a project, as soon as they are uploaded or inputted to the system, preferably remotely.

Additionally, an automatic, interactive GUI is coupled with the systems and methods of the present invention that provides the at least one multiple remote user(s) to create a visual model of a potential site for brownfield development with predetermined items for “drag-and-drop” objects that are selectively combinable to create a virtual project completed view.

The present invention may also further include decision analysis tools for helping with planning, evaluation, and/or execution of projects, including prioritization and/or ranking of projects, in addition to main benefits of the systems and methods of the present invention, including but not limited to saving money, reducing time, and ensuring positive outcome from environmental, health, and/or safety perspectives.

Certain modifications and improvements will occur to those skilled in the art upon a reading of the foregoing description. By way of example and not limitation, systems and methods of the present invention for providing risk management and containment of brownfield property assets for lenders, insurance providers, investors, stakeholders, and combinations thereof, including a key aspect of the EMS being to obtain environmental insurance, the purpose of which is to limit cost of remediation, which is often hard to project at a project's onset. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for optimized automated assessment and remediation of brownfield real estate property comprising the steps of:
providing a server computer operable with software for storing and analyzing data associated with each of three phases of development, including an assessment phase, a remediation phase, and a redevelopment phase of brownfield real estate property assets;
providing criteria for automatically determining if a project relating to a first target brownfield asset is conforming to standards for brownfield development;
assessment for remediation and/or redevelopment including a network-based computer system having interactive software via web-based user interface for automated process methodologies and/or tools for the steps for reviewing brownfield real estate property redevelopment opportunities (or project); providing at least one server computer, located centrally or distributed over a network and operable for remote interactive connection by at least one remote computer, the at least one server computer in network communication with remote computer(s) for providing remote interactive user interface with the system and for receiving inputs from the remote server computer(s) regarding data from the first target brownfield asset, the server computer operable for generating instructions for review and management of the project for any brownfield asset.

2. The method of claim 1, further including providing an environmental management system (EMS) for automatically identifying errors, problems, and/or modification of process to address and/or prevent from occurring again; self-correcting process that is built into the EMS.

3. The method of claim 1, providing a database for storing data relating to prior developed brownfield assets compared to an evaluation date.

4. The method of claim 1, wherein the instructions for review and management of the project are generated by way of automated comparison to prior developed brownfield assets and/or projects.

5. The method of claim 1, wherein the assessment step is an investment assessment for determining whether or not an investment should be made in the project that will generate at least a predetermined minimum return on said investment.

6. The method of claim 1, further including the step of providing access to a multiplicity of users for brownfield projects located over a predetermined geographic area.

7. A method for optimized automated assessment and remediation of brownfield real estate property comprising the steps of:
providing a server computer operable with software for storing and analyzing data associated with each of three phases of development, including an assessment phase, a remediation phase, and a redevelopment phase of brownfield real estate property assets;
automatically guidelines for evaluating a project relating to a first target brownfield asset; wherein the guidelines further include criteria for determining if a project relating to the first target asset is conforming to standards for brownfield development;
assessment for remediation and/or redevelopment including a network-based computer system having interactive software via web-based user interface for automated process methodologies and/or tools for the steps for reviewing brownfield real estate property redevelopment opportunities or projects; and
providing at least one server computer, located centrally or distributed over a network and operable for remote interactive connection by at least one remote computer, the at least one server computer in network communication with remote computer(s) for providing remote interactive user interface with the system and for receiving inputs from the remote server computer(s) regarding data from the first target brownfield asset, the server computer operable for generating instructions for review and management of the project for a brownfield asset.

8. A system for automatically evaluating brownfield real estate assets for development comprising:
at least one server computer constructed and configured in network communication with at least one remote computer(s) for providing remote interactive user interface with the system and for receiving inputs from the remote server computer(s) regarding information from a first target brownfield asset, the server computer including software and being operable for generating instructions for review and management of a project for a brownfield asset.

9. The system of claim 8, further including software for storing and automatically analyzing data associated with the project for each of three phases of development, including an assessment phase, a remediation phase, and a redevelopment phase of brownfield real estate property assets.

10. The system of claim 9, wherein the assessment phase includes an investment assessment to determine whether the project will provide at least a predetermined minimum return of capital plus profit on an investment of capital required to complete the project in a predetermined time.

11. The system of claim 8, wherein the system further including software for automatically generating guidelines for evaluating a project relating to the first target brownfield asset; wherein the guidelines further include criteria for determining if a project relating to the first target asset is conforming to standards for brownfield development.

12. The system of claim 8, further including visual representations of a project, including both images and text identifying the project phase is provided via an interactive website and graphic user interface (GUI).

13. The system of claim 8, further including visualization tools operable to allow at least one remote user to upload images and descriptions of respective project sites to include project image-based information in the data stored and analyzed at the remote server computer.

14. The system of claim 13, wherein the system is operable to allow uploading from remote, authorized multiple users to submit photographic images of the site(s).

15. The system of claim 8, further including visualization tools include transformation slides showing illustrations of the property “as is” prior to project commencement and what it can look like in the future at predetermined stages of the project, including project completion.

16. A system for optimized automated assessment and remediation of brownfield real estate property comprising:
at least one server computer operable with software for storing and analyzing data associated with each of three phases of development, including an assessment phase, a remediation phase, and a redevelopment phase of brownfield real estate property assets; wherein the server computer software is operable to act on criteria for automatically determining if a project relating to a first target brownfield asset is conforming to standards for brownfield development, and for automatically making an investment assessment for remediation and/or redevelopment including a network-based computer system having interactive software via web-based user interface for automated process methodologies and/or tools for the steps for reviewing brownfield real estate property redevelopment opportunities or projects; the at least one server computer, being located centrally or distributed over a network and operable for remote interactive connection by at least one remote computer, the at least one server computer in network communication with remote computer(s) for providing remote interactive user interface with the system and for receiving inputs from the remote server computer(s) regarding data from the first target brownfield asset, the server computer operable for generating instructions for review and management of the project for any brownfield asset.
